(19) United States
(12) Patent Application Publication
(10) Pub. No.: US 2004/0076941 A1
(43) Pub. Date: Apr. 22, 2004

(54) Online curriculum handling system including content assembly from structured storage of reusable components

(75) Inventors: Tammy Cunningham, Mill Valley, CA (US); William Gimbel, Oakland, CA (US); Gabriele Cressman-Hirl, San Francisco, CA (US); Steven Torrence, Alameda, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Kaplan, Inc., New York, NY

(21) Appl. No.: 10/273,427

(22) Filed: Oct. 16, 2002

(51) Int. Cl. G09B 3/00

(52) U.S. Cl. 434/350; 434/362; 434/118

(57) ABSTRACT

In a curricula system, courses are assembled from components where items are created by authors and/or authoring tools, items comprising questions, answers, narrative, media, interactions, or the like, and instructional designers design products that specify structures, strategies and the like for a product. A product, in the form of one or more course presentable to a student or other user, references reusable content items, such that a given item can be present in more than one unrelated product. A product can be represented with a hierarchical structure organized as one or more course each comprising one or more units, in turn comprising one or more modules, such as testing modules and learning modules, wherein each module in turn specifies items to be included. Products can take on one or more product template and one or more product class, wherein a product template specifies the “look-and-feel” of the product and the product class defines basic course structure and functionality. Items are atomic objects that are reusable across products, courses, units, etc. The atomic objects can be created in advance and can be stored in a non-product specific manner.

### BACKGROUND OF THE INVENTION

The present invention relates to testing and learning systems in general and in particular to testing and learning systems where components are reusable.

Testing and learning systems (generally referred to here as “curriculum systems”) have been used in many environments. For example, teachers might use them in the classroom to present material, test students, or both. As another example, regulatory bodies might test applicants as a precursor to granting a license (e.g., attorney exams, NASD qualification exams). As yet another example, schools or academic associations might use tests as an indicator of student aptitude and preparedness (e.g., SAT, MCAT, GRE, LSAT). Providers of testing and learning services might often need to provide practice tests and curricula for such tests. For example, a curriculum system might be used for preparing a student for taking a standardized test by giving the student practice questions, then simulating an actual test and, where appropriate and possible for the testing topic, provide learning along with testing. For example, where a student is preparing for a contractor's exam, the curriculum system might provide sample tests and lessons in areas of a student's deficiency.

Where a provider of testing and learning services supports students in many practice areas, the management of tests, lessons and other materials needed becomes difficult. In some cases, the processes can be managed well when the topics do not change very often, by publishing paper materials that are copied for each student. However, where the material changes, such as reorganization of standardized tests, updates to the topic (such as changes to what is covered in a particular exam, updates to the laws for legal/contracting/regulatory, etc. tests) and the like occur often, or the students expect online access to the curricula, simply printing one version of a course and reprinting it will not be feasible. In addition, where each course is independently handled, there would be much duplication as questions, narrative, images, and other elements are distributed over many different forms of content. Therefore, improved systems and methods for handling elements of curricula systems were needed.

### BRIEF SUMMARY OF THE INVENTION

In one embodiment of curricula system, courses are assembled from components where items are created by authors and/or authoring tools, items comprising questions, answers, narrative, media, interactions, or the like, and instructional designers design products that specify structures, strategies and the like for a product. A product, in the form of one or more course presentable to a student or other user, references reusable content items, such that a given item can be present in more than one unrelated product. In some embodiments, a product is a hierarchical structure organized as one or more course each comprising one or more units, in turn comprising one or more modules, such as testing modules and learning modules, wherein each module in turn specifies items to be included. In specific embodiments, products can take on one or more product template and one or more product class, wherein a product template specifies the “look-and-feel” of the product and the product class defines basic course structure and functionality. Items are atomic objects that are reusable across products, courses, units, etc. The atomic objects can be created in advance and can be stored in a non-product specific manner. The following detailed description together with the accompanying drawings will provide a better understanding of the nature and advantages of the present invention.

### BRIEF DESCRIPTION OF THE DRAWINGS

FIG. 1 is a block diagram of an online curriculum system according to one embodiment of the present invention; FIG. 1A is a high-level view; FIGS. 1B-1C show additional details.

FIG. 2 is a data diagram illustrating a data storage arrangement that can be used by the system shown in FIG. 1.

FIG. 3 shows more detail of the data diagram of FIG. 2; FIG. 3A and 3B show different aspects thereof.

FIG. 4 is an illustration of a reference scheme.

FIG. 5 is an illustration of a search process.

FIG. 6 is a high-level representation of a search system.

FIG. 7 is a template mapping diagram.

FIG. 8 is an illustration of a Product Definition XML (PDX) file example.

FIG. 9 shows a process of content authoring.

### DETAILED DESCRIPTION OF THE INVENTION

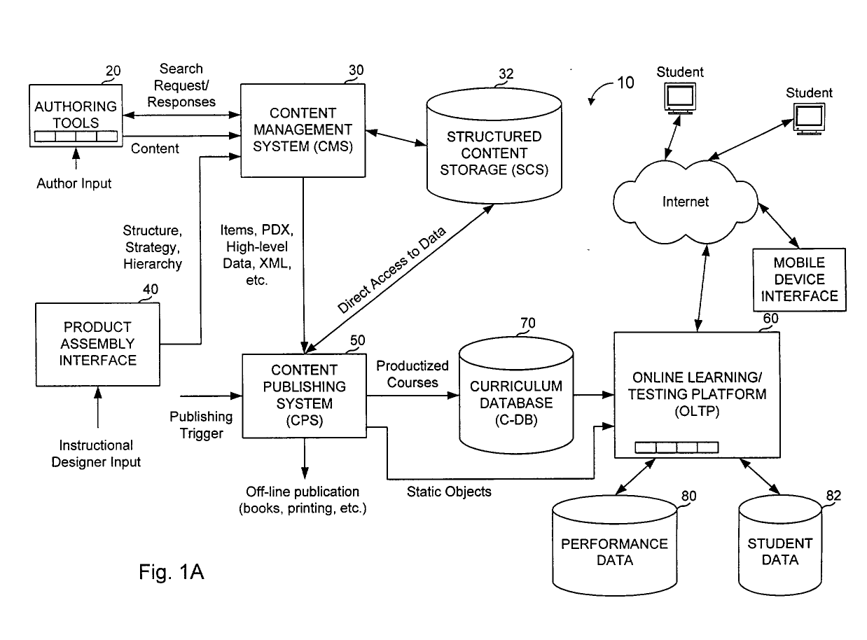

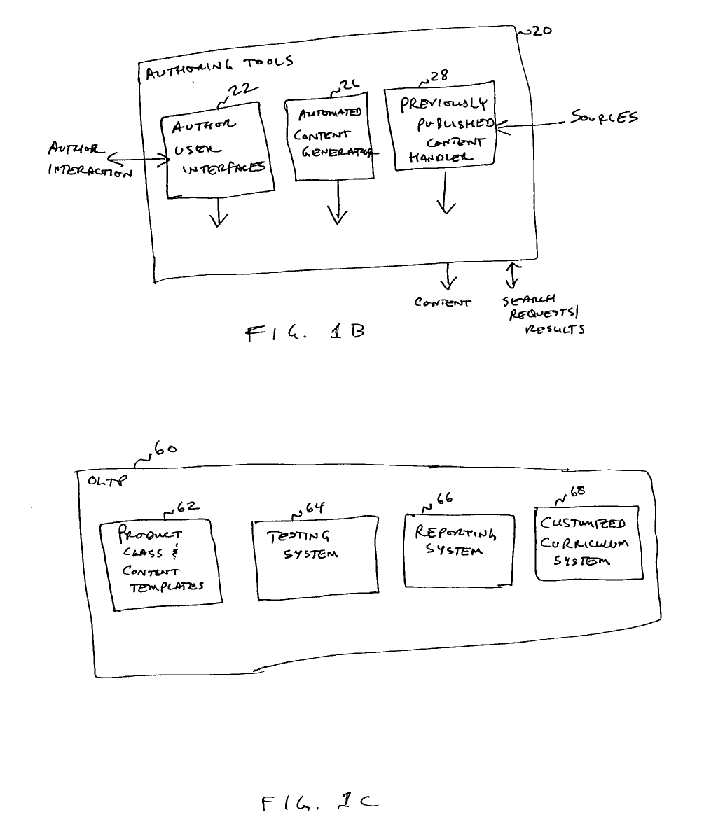

FIG. 1 is a block diagram of a curriculum system 10 according to embodiments of the present invention. As used herein, curriculum refers to lessons, workshops, tutorials, activities, customized drill and practice, pre-defined assessments, examinations, or the like. A curriculum can comprise lessons for student education, or no lessons. A curriculum can include one or more tests in a practice setting, a simulated test setting or an actual test setting. A curriculum is directed at one or more students, wherein the students can be individuals that seek to learn a subject, to identify their deficiencies in areas of knowledge, to test themselves on areas of knowledge, to prepare themselves for taking tests outside or inside the system, and/or related activities. A curriculum can have an identified study plan that might be linear and predefined, or prescriptive with one or many iterations of prescription.

Using curriculum system 10, a curriculum administrator can create, manage and deliver interactive curriculum to students. As shown, curriculum system 10 includes authoring tools 20 coupled to a content management system (CMS) 30 coupled to a structured content storage (SCS) 32. CMS 30 is also coupled to a product assembly interface 40 and a content publishing system (CPS) 50. As shown, CPS 50 includes a direct link for accessing data in the SCS without going through CMS 30. It should be understood that other interactions, links and associations not explicitly shown might exist, as a person of ordinary skill in the art would understand. The CPS is shown coupled to an online learning and testing platform (OLTP) 60 and a curriculum database (C-DB) 70. SCS 32 might be an XML database or other structured storage and C-DB 70 might be an XML database, a hierarchical directory in a file store, a compressed structure of files, or the like. The OLTP is coupled to a performance database 80 and a student database 82. Also shown are student interfaces to OLTP, such as by Internet access using a browser on a desktop computer or other computer, or via a mobile device interface as might interface to a cellular telephone, a handheld computer, or other mobile device.

Curriculum system 10 can be a stand-alone system or integrated with existing learning management systems to allow for the tracking of students usage and progress through their study. Curriculum system 10 provides curriculum authors with a set of authoring tools usable to create atomic instructional objects, including test questions, media and other objects. Referring now to FIG. 1B, authoring tools 20 might comprise an author user interface 22, automated content generators 26 and input modules 28 for previously published content, such as books, CD-ROMs, articles, scanned papers, electronic articles, web pages, etc.

Authoring tools 20 allows for administrators and content creators to create objects elements. For example, an author might be provided with a graphical user interface (GUI) to an XML editor to allow for authoring content, including appropriate metatags used for assembly of products by product assembly interface 40 of CPS 50. The authoring tools might also provide the ability to search for and/or edit content already stored by CMS 30 in SCS 32. Some of the metatags might be configured so that question or lesson item content can be repurposed for online and/or print uses, categorized within multiple curriculum and organizational taxonomies, and tracked for the protection of operator and/or author intellectual property. For example, a question might include metatags identifying the question as a hard question, a math question, a finite algebra question (being more specific in a taxonomy than the “math” metatag), as well as metatags identifying the author of the question and concomitant intellectual property rights.

CMS 30 stores and manages content in a presentation-neutral format, such as XML, structured text, SGML, HTML, RTF, or the like. CMS 30 also can track ongoing creation and modification of content using version control techniques, as well as support access controls for intellectual property, user-management and security. CMS 30 might support the use of the proprietary authoring and search tools, the storage and deployment of traditional curriculum, including simple to complex question types (e.g., multiple choice, picture marking, fill-in, line drawing, etc.) as well as exact emulations of the layout and functionality of questions on computer based standardized tests (e.g. GRE, GMAT, SAT) and the items and structure can be independent.

CMS 30 can also be configured to store rich media assets including graphics, animations, and audio and video clips associated with question and lesson content. Some of the functionality of CMS 30 might be supplied by off-the-shelf software. For example, content management functions such as workflow, versioning, XML storage, Document Type Definition (DTD) editing for structured content storage, etc., might be provided by a product such as Broadvision's One-to-One Content Management System. As shown, the data maintained by CMS 30 is stored in structured content storage (SCS) 32, but in some embodiments, CMS 30 and SCS 32 might be more integrated than is implied by FIG. 1.

Product assembly interface 40 allows an instructional designer to design a product, course, lesson, test, etc., from content in SCS 32. Product assembly interface 40 can be used to capture features a product should contain, record these settings in a form CPS 50 can understand and identify what instructional content will be included in a course of study or testing. Thus, product assembly interface 40 can provide structure, strategies and hierarchies for a product or components thereof. The designer is often different from the author, as the authors create items and the designer builds a product from those items, specifying how it all comes together. However, nothing prevents the same person from being an author and a designer. One benefit of the system shown in FIG. 1 is that both the author and the designer can be nontechnical and provide input in an intuitive manner.

A typical assembly process comprises two sets of documents: (1) a Product Definition Parameters (PDP) document that captures product features and structure in a checklist fashion and (2) a PDX document, which is a more machine-readable version of the PDP. The PDX file is used by CPS 50 to enable automated publishing of curriculum and media assets from SCS 32 to OLTP 60, upon receipt of a publishing trigger. CPS 50 can work with CMS 30, but in some cases, it might be more efficient for CPS 50 to read directly from SCS 32. In some embodiments, OLTP 60 includes designer inputs, to allow for automatic control of settings, such as the form of the output (HTML, XML, print, simplified for mobile devices, etc.), as well as administrative rules and settings such as look and feel settings, instructional design settings, etc.

If CPS 50 publishes a product in off-line form, the output can be camera-ready pages, PDF files or the like. If CPS publishes a product in on-line form, the curriculum is sent to C-DB 70, but some static elements, such as media components, text, etc. are provided directly to OLTP 60. Some of those static elements might be stored on a fast Web server storage unit for quick feeding to users as needed.

OLTP 60 can provide a broad array of online learning products using curriculum deployed from the CMS. The platform allows for the flexible selection and utilization of learning components (e.g., tests, tutorials, explanations) when designing an online course. FIG. 1C shows some components of OLTP 60, such as product class and content templates 62, a testing system 64, a reporting system 66 and a customized curriculum system 68.

Thus, the assembly interface can be used to provide structure and relationships of the atomic elements informing the system of their instructional design strategies, and publishing tools can auto-generate code and create a final product bundle to be delivered to the student in a context appropriate for their use. In a specific implementation, C-DB 70 is an Oracle database and OLTP 60 includes an interface to that Oracle database, an interface to middleware such as Weblogic's product and a Web server interface.

Content Management System

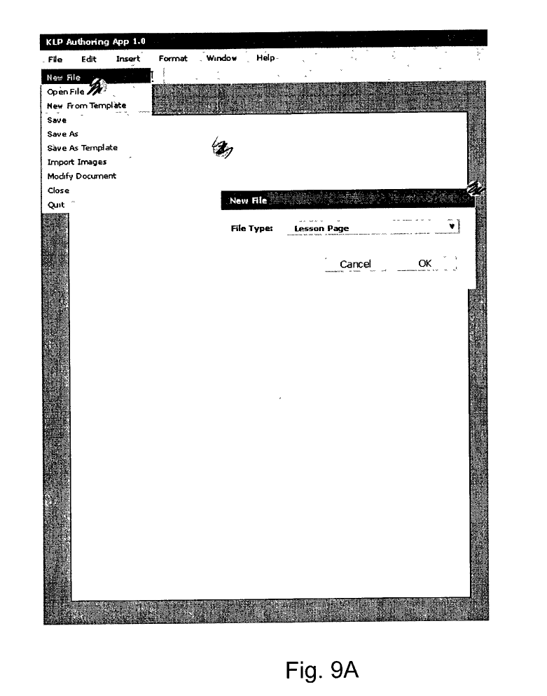

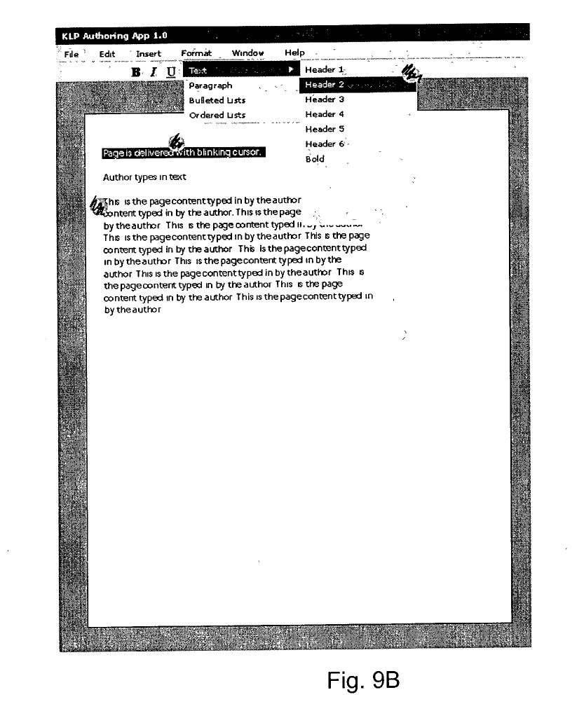

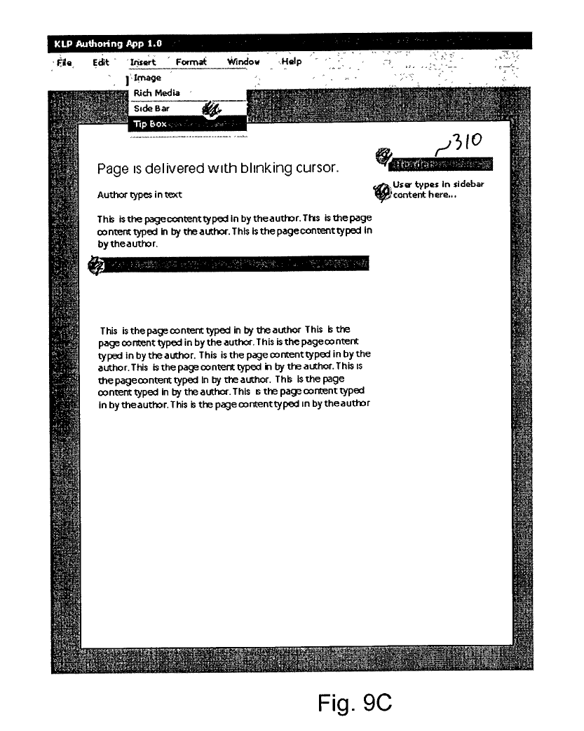

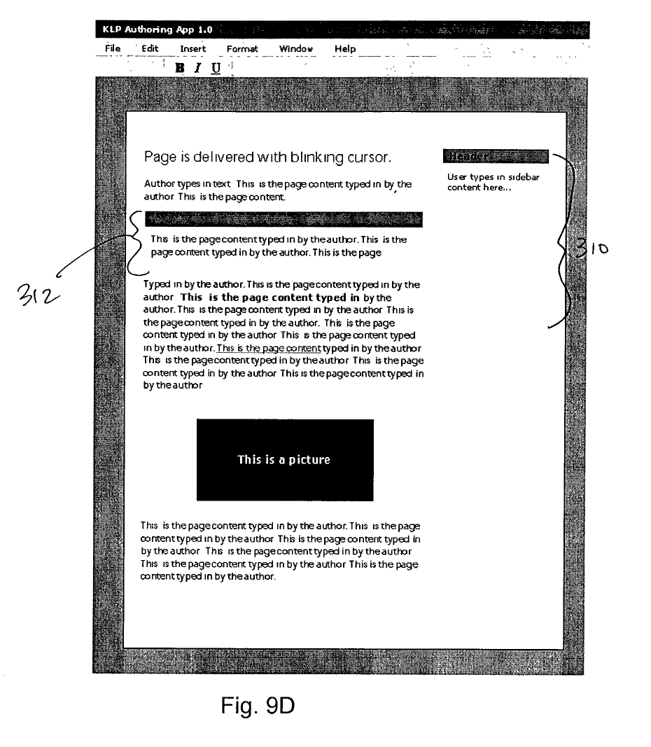

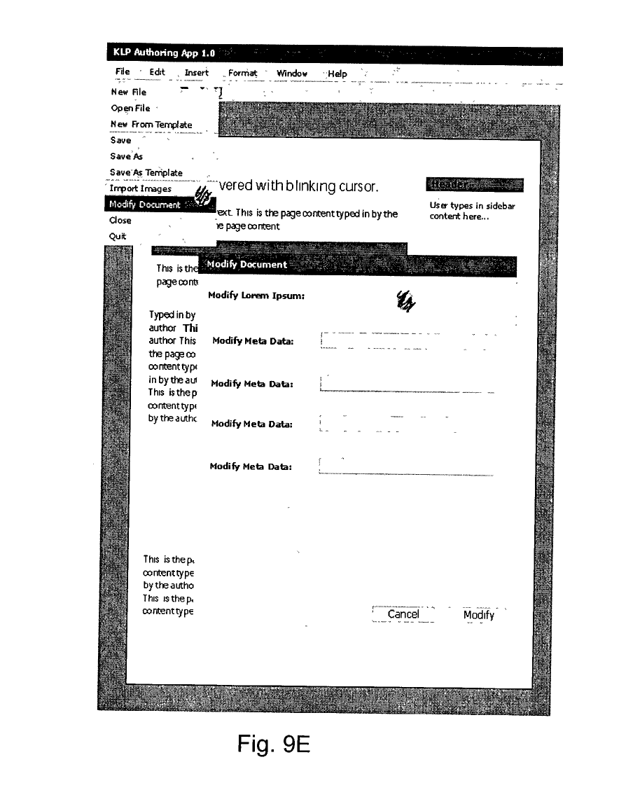

Once files are created as shown in FIG. 9 (below) or by other methods, they are stored in structured form into SCS 32 by CMS 30. One content management system that could be used is Broadvision's One-to-One Content system. Such documents could be stored as XML documents generated by Kaplan's authoring system and automated parsing tools. In one embodiment, XML documents are stored in a repository with a project and directory metaphor. As used herein, the term “item” is used to refer to objects stored by CMS 30 as atomic units. In many products, each item is presented to the student separately, such as by clearing a screen and using the entire screen to present the item, without other items being present.

Preferably, items are stored by CMS 30 using globally unique identifiers (GUIDs). When a product is created, a list of items, identified by their GUID, can be created. The CPS extracts the items from CMS 30 according to this list and compiles them for use in the specific product. In this way, any single content item may be referenced by several products with no further modifications or editing required.

As an example, a product might be a particular test for a particular market and set of students. If the test contained 1000 questions, in various places, the list for that product would reference those questions in the CMS by their GUIDs. One advantage of this approach is that questions can be authored and stored separately, then labeled in the CMS using a contextually neutral GUID. The questions do not need to be aggregated for use in the product until the time of publishing the product, and the questions can be reused easily from product to product and can be updated in one place and have the updates propagated throughout all new and republished products.

In order to find items easily and according to specific product requirements (e.g., every “hard” math question, etc.), items might further include associated metadata that describes the content in a product-neutral manner. Thus, general taxonomies may be used to organize items before they are placed in specific products.

Platform Data Model

The data stored in the CMS can be structured according to the platform data model described herein. The platform data model is optimized for the re-use of content. A referential document model fulfills this objective, where atomic units of content (items), such as questions, media, lesson pages, glossary words, etc., are provided GUIDs.

In addition to items, the CMS might also track products and references. Thus, in the basic system, there are three classes of data: content, products and references. Content includes questions, media and other content, without requiring any specific product-contextual information, which is preferably absent to allow for easy reuse. Product data includes product item, product delivery rules, PDX files, etc., containing product-specific information about referenced content items or product items, including categories, difficulty levels, user interface display instructions, rules to be applied to referenced content, etc. Referential data includes pointers between items and products and/or items and items (and possibly even products to products).

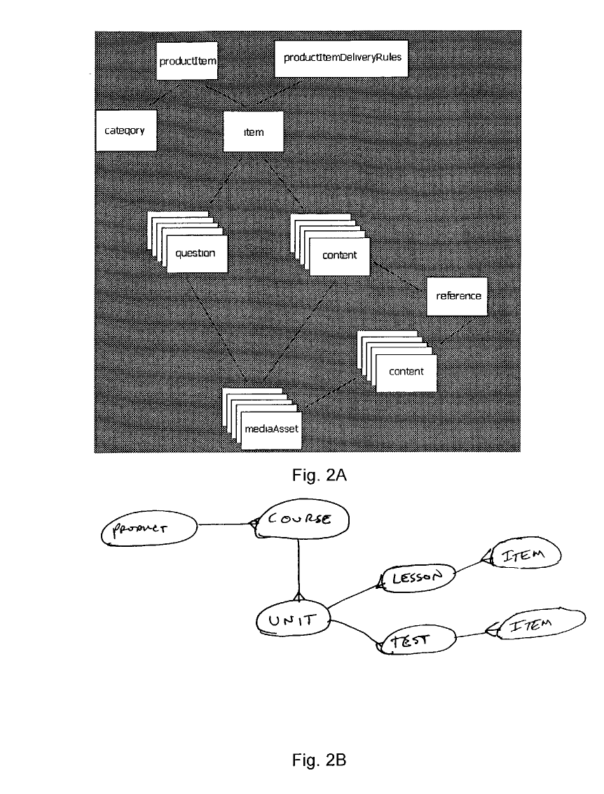

FIG. 2 illustrates an example of data structures according to the platform data model, showing productItem records, productItemDeliveryRules records, item records, category records, content records, question records, media asset records, and the like. FIG. 2A illustrates an example of XML document types according to the platform data model, showing productItem, productItemDeliveryRules, item.xml, category.xml, content.xml, question.xml, mediaAsset.xml, and the like. These document types contain x-link references that determine their relationship to other document types.

FIG. 2B shows one possible structure for data defining the hierarchy of a product, such as courses, units and modules. For example, references to a number of items might be grouped to form a lesson module and other references grouped to form a test module. These modules can be grouped into a unit and one or more units would comprise a course. Each course can be a product, but a product might also comprise multiple courses. As used herein, “plannable component” refers to one of the building blocks of products, including units, lessons, tests, tutorials, references, tools and the like. In particular embodiments, these are the building blocks available to a designer, so that any block a designer can select or unselect for a product would be a “plannable component”. A product must have at least one plannable component, but there need not be a limit to the number of components a product can have. Each plannable component has a unique set of properties and functionality that is used to customize its operation within a course. These plannable components end up being identified as such in the product definition file(s) for the product.

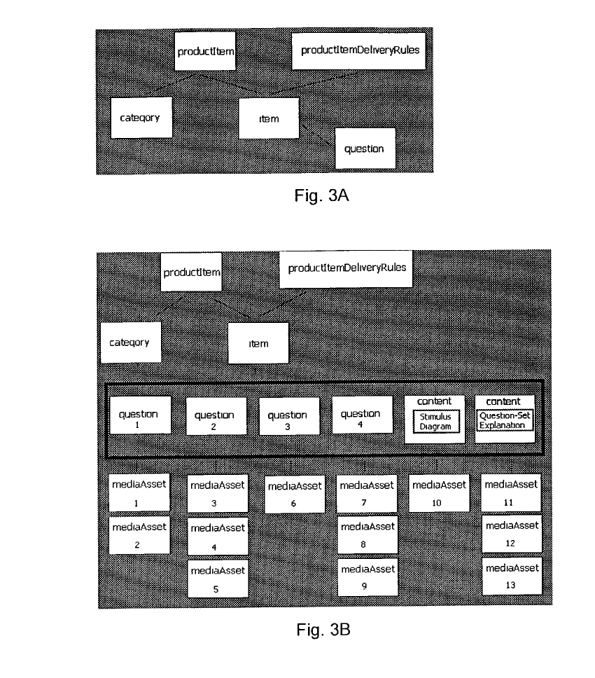

FIG. 3A illustrates the structures of the data model that might be used for authoring a simple text-only question, such as an “analogy” question. FIG. 3B illustrates the structures of the data model that might be used for a data interpretation question-set. As shown there, a productItem record has a category and an item, which in turn has a productItemDeliveryRules record. The item record relates to a set of questions, media assets and other content, such as a stimulus diagram and a question-set explanation. Both content and question files can link to a reference file.

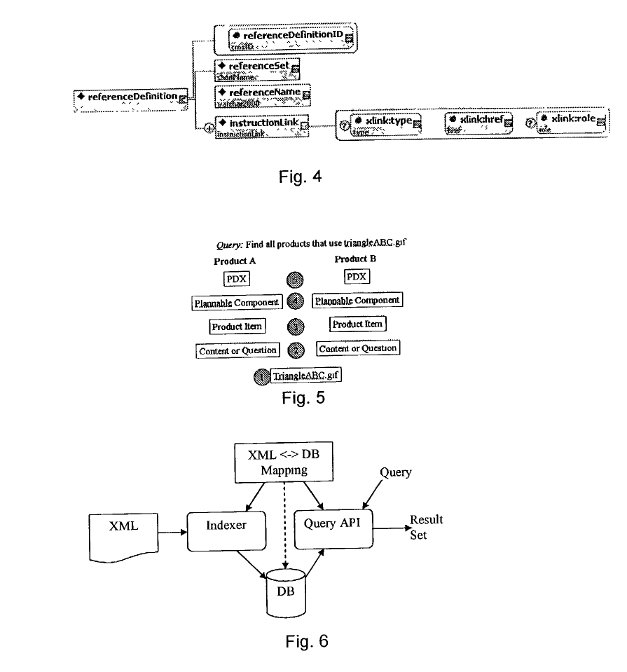

A reference file is based on a reference schema, such as the one shown in FIG. 4. In that schema, the root element of the reference schema is <referenceDefinition>. The element <referenceDefinition> contains the name of the reference and the name of the set the reference belongs to, but it does not contain any of the text/images of the reference itself. For this, it links to one or more content files.

Presentation-Neutral Item Structure

While the document-centric nature of the platform data model supports re-use, the use of presentation-neutral constructs within each document type further supports the ability to abstract pure content from how it might be realized in a particular product. For example, the following sentence could be part of a question item:

The book, “Tom Thumb” is about a fictional character of the 18^{th} century.

The XML-encoded version of this sentence might be:

<matinline> The book, <bookTitle> Tom Thumb </bookTitle> is about a fictional character of the 18^{th} century.</matinline>

By using the term “bookTitle” to describe a particular type of phrase or term, the actual visual presentation of “Tom Thumb” could be realized in bold, underline, etc., according to the demands of a specific product. Each product description document (see below) contains a set of preferences that can be unique that map these presentation requirements to the actual product.

One advantage of using a presentation-neutral item structure is that the details of test strategy, presentation, look-and-feel can all be separated from the items that will be used in a product, thus allowing items to be created once and course plans created once, with each of those being reusable and relations between which items are in which courses to be flexibly applied. Furthermore, where the items and course plans are provided in a structured form, they can be edited by possibly nontechnical users. This would allow, for example, a designer to design a new course from previously used content and/or new content, with a varying presentation and structure, all without having to reprogram the system (such as OLTP 60 or CPS 50) that presents or publishes the course. Thus, a product could be created “on the fly” as a designer selects templates and content and those selections are stored in SCS 32.

The structure for item storage described herein also allows for easy updates. For example, if the answer to a question changes (“Who is the current President of the United States”?), the change only has to be made to the question items that change. When a course is republished, it will be again constructed from the items and the PDX files and the answers will appear updated.

Because both the content and the structure of a course can be easily changed, a course designer could easily vary strategies to determine which strategies allow students to learn better. Where the course is published online, the course designer could vary the strategies on a very fine schedule to quickly fine tune the process. This fine tuning might be part of a feedback system wherein students take tests, their performance is monitored (e.g., right answers, time delay between interactions, help used, etc.) and those results are used to rank different strategies so that the optimum strategies can be used.

With the tools described herein, the variations of items, strategy and other elements of a course can be created and manipulated by editorial staff instead of requiring programmers and other technical staff, thus allowing the course creation by those closer to the educational process. Where only one product or course is being created, this is not an issue, but it becomes a significant issue where many courses, in many areas, are to be created and administered.

CMS Search Engine

The unique, referential nature of the platform data model can be easily searched using the search engine described here. The search engine can intelligently negotiate the references and find individual items in the context of their various parent and child relationships. The CMS search engine extracts individual XML items in the repository, transforms them to a searchable view, casting off elements that are not required for search, resolves the references and then maps the data to a series of database tables. This search engine might be accessible to authors via authoring tools 20 and to designers via product assembly interface 40.

FIG. 5 illustrates an example of a search as might be performed by the CMS search engine. Suppose a user needs to find all products that use a media object named “triangleABC.gif.” Following are the logical steps for carrying out this search, as shown in FIG. 5:

1) Find the media object triangleABC.gif and verify its existence in the repository.

2) Find any content or question that contains a reference to triangleABC.gif.

3) Find any product items that refer to the contents or questions found in Step (2).

4) Find any plannable components that refer to the product items found in Step (3).

5) Find any PDX files that refer to the plannable components found in Step (4).

The searchable view component of the search engine allows for resolution and storage of these relationships before insertion into the search database, thus pre-empting the need to actually traverse the items in the course of a search.

FIG. 6 is a high-level visual representation of the search system. The search system extracts new files from the repository and inserts the updated information into the database on a periodic basis. The XML Mapping mechanism is modular in the sense that if a new schema is created, only the mapping needs to be adjusted to match the new schema. Underlying processes automatically update or re-format the database to match the new data model.

In one embodiment, the search engine is built as a set of Java classes that are exposed to developers as a toolkit accessed by Java APIs. Developers can then build any user interface above this toolkit and access the functions of the toolkit via the APIs.

Product Assembly Interface

Product assembly interface 40 provides a method for applying product level parameters to content that will be assembled into a product and includes a set of tools and processes used to record and communicate the product settings to content publishing/delivery system (CPS) 50, usually via SCS 32. Product assembly interface 40 captures information on the product structure and operation. Preferably, all assembly information can be recorded into a series of XML files and Product Definition XML (PDX) files, such as the examples shown herein.

The PDX files reference content and media to be used within the product, directly or via “indirect” file references. Such information includes category definitions, definitions of which user interface files to use on particular categories of content, definitions of what rules will be applied to certain categories of content, such as gating and evaluation, variable help and introductory copy. Other information might be included, such as references to every items used in the product (and indirectly every content question and media item), as well as component names and test names and rules.

The PDX files might also include indications of course strategy. For example, a course's specification might include reference to pluggable components of code and/or rules used by the OLTP to control various aspects of the curriculum and user experience. Examples of such interactions include, but are not limited to, item selection, next item, performance calculation, question evaluation, scoring, section completion, section passing, test completion, termination, course control, achievement criterion, parameter validation and study planner.

Content Reuse

The system supports at the following content reuse scenarios, as well as others that should be apparent from this disclosure. The first is selecting specific content units for use in other products; content would remain unchanged and inherit any changes made to the source file. Another scenario is reuse subset, wherein the system supports a subset of content reuse, i.e., content copying. Authors will select a content unit or an individual file and make a copy of it for use in another product with no links made back to the original source file. The copy will receive a new identifier (GUID, RID, QID, etc.).

The Global Unique Identifier (GUID) is a number is generated using algorithms ensuring that it is globally unique. Resource Identifiers (RID) or Object Identifiers (OIDs) are IDs assigned to identify an item. These IDs may or may not be unique and are managed by the system that assigns the RID. Question Identifiers (QIDs) are unique IDs within the scope of the platform, typically displayed to the customer or other end-user, used to identify a piece of instructional content during service calls.

Some actions performed by product assembly interface 40 will now be described. When a designer is specifying a product, the designer specifies a product class and product template that the product will use. Selection of the product class determines structure of the PDX and components usable within the product. The product template determines the product's UI (user interface) and content organization. In some embodiments, the product assembly interface enforces product class and product line selection prior to allowing the designer to proceed with product creation. A product's class determines a specific structure of the PDX and the component(s) used within the product.

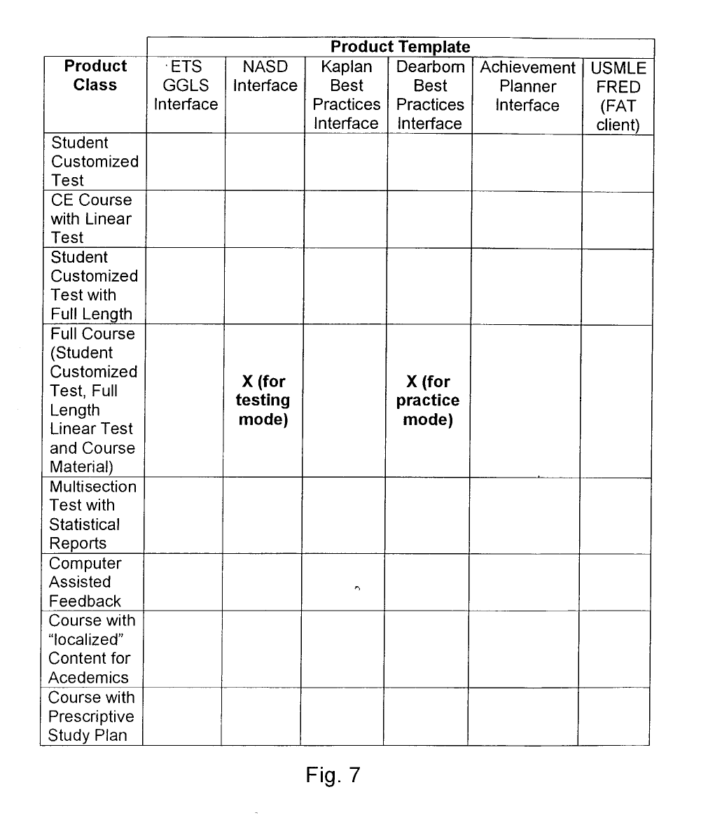

Examples of product classes are shown in FIG. 7. Products within the same class, regardless of content, share the same basic structure and functionality. A product's line determines the presentation of the product, including UI color scheme, look-and-feel, content taxonomy, how to present questions on the screen, etc. Selecting the product line will set values within the PDX corresponding to the user's selection. Typically, the product line represents a set of test, instructions, materials and/or offerings that have a common market segment. For example, one product line setting could be for the GRE, another for the LSAT, another for the GMAT, etc.

Based on the product class selected, a list of product components will be presented to the designer. The designer will create the course structure by indicating which component to use along with order and name for component. Course structure might include the type of product component and a sequence in relation to other components at the same level within the course. A PDX file might exist for each product class and the product classes and product lines are preferably editable for ease of making changes. With a moderately sized set of product classes and product lines, the designer might be presented with a matrix interface essentially like the table shown in FIG. 7 and be allowed to select one or more cells of the matrix to define the product class(es) and product line(s) for a product.

The product assembly interface 40 enforces component use rules dealing with acceptable component hierarchy (e.g., option of having lesson pages limited to being added to lesson components) and required unique entries (component names). Content validation or pedagogic validation need not be performed. The designer can modify a course structure at any time during product creation, but components selected by the designer, along with sequencing information, will be written to the PDX prior to allowing other user actions.

As part of product assembly, the course designers choose the presentation templates that will map to a product. Authors user elements of the system to create items and lesson content, while course designers design the pedagogy and flow of a course/product. In addition to selecting product classes and lines, the designer might also specify which content to use and add strategies, reports and the like, to the product. In some cases, someone can be both an author and a course designer, but the system allows for separate specialties to be used easily.

Examples of Presentation Template Functions Include:

1) Template Assignments: ID/CDs assign products (from a course, unit, lesson or individual page basis) to platform presentation templates using a WYSIWYG tool. This includes general templates (for quizzes, activities, tests) and specific templates (for particular lesson page configurations, such as content with a left sidebar, content with no sidebar, etc.). Templates are chosen from a library of predefined platform templates.

2) Course Parameters: Based on the Class, parameters are presented to the designer for setting course/component operation and allowable assembly operations. The line selected by the designer determines the options available for each parameter. Two groupings of parameters that might be presented to designers are product parameters and assembly parameters.

Product parameters set how the product will perform. The values are entered into the PDX. Assembly parameters specify how the assembly tools will interact with the product being created and define allowable action. The selections made by the designer are not required to be written to the PDX, but should be stored for use while designers are creating the product.

The instructional items used within the product have parameters set that impact product performance and how the content is handled in the repository. Similar to the course structure requirement for sequencing of components, instructional items have a parameter set that determines its sequence among all items within the component. Categories are a taxonomy used to organize the content for organization, reporting, and presentation within the platform and product. The product line defines the acceptable categories for use within a product. The designer selects one or multiple categories, from predefined lists, to assign to the item.

Product Definition Parameters File

All of the product definition parameters can be stored in a PDP file in a format such as that shown in Appendix A as Table A.1. It should be understood that the specific format shown is not required and other formats might be used just as well. For example, the PDP might be presented as a set of checkboxes to be filled in.

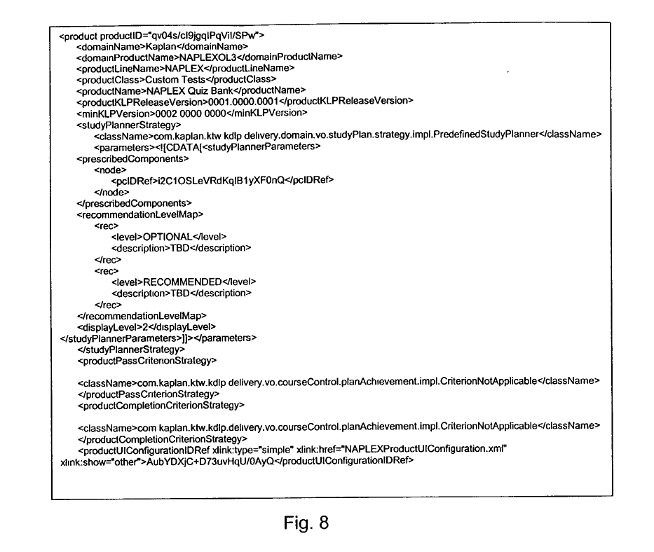

In actual storage, the product definitions would be in a more “machine-readable” form, such as a Product Definition XML (PDX) file (or files) as illustrated by the example of FIG. 8. A PDP file might be created using a checklist provided to the designer through the product assembly interface 40.

From a completed PDP, the PDX documents can be created. The PDX are a set of documents that capture the product features and curriculum structure in a form that can be understood by CPS 50. The parameters documented in the PDP are converted to a structured XML format, and acceptable settings that the CPS will use to create the product. The PDX document structure, while a unique format used to instruct the CPS, can vary by class of product and structure of the course.

From the PDX, the CPS can determine information needed for packaging a product for publication, such as 1) uniquely identifying the course(s) being created, 2) the course parameters defined in the PDP in a machine readable form, 3) the relationships between all components of the course (units, lessons, tests, deliverable pages, etc.), 4) references to all curricular content to be used in the course, and 5) the rules the OLTP will use for presentation, course navigation, and evaluation of the student's interaction with the course. The CPS interprets these instructions during transformation of the course content into a deployable OLTP course.

Based on the product class, a specific list of features and options are available within the PDP. The product design and feature set is created as the designer selects from predefined options for each feature. The options are textual descriptions of the expected functionality for a specific feature. When completed, the PDP provides a detailed description of the products expected functionality and performance in “human-readable” form.

The completed PDX describes a complete and unique product. CPS 50 can read the PDX to learn what instructional content to include and how it should be presented and from that generated a product where the content and instruction on how the product should perform within the platform (such as how it interacts with its users if it is an online product, or how it looks on the page if it is a printed product) are packaged within a single unique deployable package.

Content Publishing System

The CPS is coded to interpret information within the PDX files and to compile the reference instructional content and instructional rules into a finished product. The CPS extracts all of the data related to a single course as defined within a specific PDX document [examples shown in FIG. 8] contained within the CMS. References to curriculum components, such as those shown in the structures of FIGS. 2-4 and 8 and might include test questions, lesson pages, media assets and strategies, are resolved to the actual implemented components contained elsewhere within the CMS and SCS 32. The data is then transformed and packaged for final delivery. In the case of curriculum to be delivered online, the OLTP 60 extracts the package and inserts it into C-DB 70 for future delivery or the CPS provides it to C-DB 70.

Online Learning and Testing Platform (OLTP)

One of the publishing routes is to publish to an online learning/testing platform (OLTP) 60 that provides products in online form. Within the OLTP, products designed by course designers include online delivery of curriculum (including tests and assessments, explanations and feedback, lessons and customized content) to customers and this might be done via a standard Web browsers and Web protocols.

OLTP 60 can also generate reports on student performance and to provide custom interpretation a student can use for future test preparation and study planning as well as deliver to students functionality for the student to self select learning modules or to have the platform automatically prescribe customized curriculum based on assessment results and student entered preference information.

Delivered products can be used in a self-study mode, including (1) simple single topic linear tests, multi-sectioned tests with scaled scores, or student customizable practice tests, (2) diagnostic assessments with simple score reports or diagnostics providing rich narrative feedback and recommended study plans, and (3) complete courses with tests and lesson tutorials delivered in a simple linear pedagogy or individualized courses, customized to meet unique student learning needs.

The OLTP provides the designer with the choice between working from a pre-set structure defining a particular product class or to select subcomponents that compromise an existing structure to create new product classes. Three examples of pre-defined templates used to define a product in the OLTP are the product class templates, the product branding templates and content interface templates. Product class templates might be:

1. Student Customized Test

2. Continuing Education Course with Linear Tests

3. Student Customized Test with Full Length Linear Test

4. Full Course (Student Customized Test, Full Length Linear Test and Course Material)

5. Multi-Section Exam

6. Computer Assisted Feedback

7. Course with Localized Content for Institutions

8. Course with Prescriptive Study Plan

Where the designer can select product classes, such as by selecting cells in the matrix shown in FIG. 7, the designer might select multiple product classes and product branding templates. Product branding templates might provide a particular provider's look-and-feel or emulation thereof, such as:

1. Financial Best Practices Interface

2. Real Estate Best Practices Interface

3. Kaplan Test Prep Best Practices Interface

a. K-12 Achievement Planner

b. Generic Test Prep

4. Testing Service Emulation

5. Other

Content interface templates might include question type templates, response type templates, lesson interface templates and the like.

Testing System

The testing system supports online and offline administration of tests. Tests can be defined as a series of questions grouped and administered in a variety of interfaces that can be presented in numerous formats including short practice quizzes, sectionalized tests and full-scale standardized test simulations and review or practice. The student interacts with this content in various ways, while the system tracks data about these interactions: answers chosen, time spent, essay text, and more. For tests administrated offline, the testing system can receive the data through a proxy. The system supports a variety of item administration rules, including linear, random, student selected (custom), and adaptive testing. It also supports rules governing the way a test instance is presented to the user (e.g., test directions, help, breaks, etc.). The testing system might specify or control the following aspects of a test process:

A. Ability to define passing criteria per test

B. Ability to define timing by test, by category, by item

C. Ability to define test class, e.g., pre-test, post-test, and organize reports based on test class

D. Ability to define recommendation level, e.g., required, optional

E. Ability to reuse items across tests and across products

F. Ability to define secure items that can appear in a given test or product only, e.g., a final exam

G. Ability to develop tests that emulate the standardized computer based tests including multi-section administration, scaled scoring and adaptive delivery

Many different types of tests can be accommodated by the testing system, with potentially unlimited number of tests of any type per course. Test types can be mixed and matched. For example:

1. Customizable tests (Qbank and Drill and Practice)

a) Ability to create any number of custom tests (based on reuse, difficulty level, category) from a single test definition.

b) Ability to create multiple Custom Test “factories” or test definitions in a single product, e.g. you can define subject-specific Custom Tests for individual Units and a comprehensive Custom Test that covers all course material.

2. Predefined linear and multi-section tests

3. System-generated linear tests with the following variations:

a) Ability to generate new test with shuffled (but otherwise same) set of items

b) Ability to generate new test with fresh selection of items based on item selection rules defined by the product designer.Ability to define a test that combines a set of predefined (static) items with a set of system-selected items based on item selection rules defined by the product designer

Many different types of delivery modes can also be supported, such as Practice, Test Simulation, or Examination modes. Additional configurable features include timing on/off, timing definition, feedback on/off, explanation on/off, ability to return to previous item on/off, test suspend/resume on/off. Delivery modes are assigned to each test and can be mixed and matched. Multiple takings of a given test is supported, with performance and history tracked and reported for each taking.

Performance Calculations (Scoring)

Performance calculations allow a student's responses on an evaluated Exercise Component or Test Question to be translated into one or more scores. A score may be used for student self-monitoring, an official certification, or for estimation of potential performance on an actual test. For example, in a continuing education course, a student's final exam score may be compared to a predefined passing criterion to determine if certification should be issued.

One simple performance calculation is a raw score expressed as the percentage of correct responses divided by the total number of questions in a test. More complex performance calculations involve penalty calculations and scaling conversions.

The testing system can provide a logic based assessment system that is based on a computer assisted feedback (CAF) system, such as the current Kaplan Computer Assisted Feedback System. The CAF system can be used in test preparation education centers to assess paper and pencil tests administered in the centers. The online system administers the tests online or allows the student to input the answers on paper-based tests using an online score sheet user interface.

Some examples of CAF logic tests are shown in Appendix A, as Table A.2. In these examples, a test is preformed on a given number of test items and the criteria for determining which diagnostic outcome to recommend is based on determining if the test is true for the greater number of items in the set, as opposed to an equal number or a number less than the specific criteria. Ways of changing the diagnostic strategy are to change the number set or change the default consideration from “greater than some number” to “equal to ” or “less than”. These tests generally assume that questions are numbered consecutively throughout the test (e.g., Section 2 begins with 31, not 1).

Assessment feedback can be based on a series of logic tests that provide a significant degree of individualized assessment of students' strengths and weaknesses as assessed from a diagnostic test or a combination of a diagnostic test and questions from the student profile. The assessment rules are used by the platform to deliver both 1) an individual diagnostic reports package for a customized student report and/ or 2) the recommendation of learning components of an individual prescriptive study plan.

Reporting

The OLTP delivers individual student reports from within a single specific product, but other variations are possible. A student report is an expression of performance on an evaluated component, presented in a format easily understood by the student. The reports component encompasses the data and methods used to produce this student-interpretable information.

Student reports for a course may be the standard reports, such as those providing percentage scores for tests and categories and item analysis for correct and incorrect responses or more sophisticated reports. A diagnostic reporting process (DRP), which might be part of reporting system 66 illustrated in FIG. 1C, provides information on a student's performance on a diagnostic test in specific categories that can be used by the student to identify content strengths and weaknesses in particular content areas. The greater level of detailed reporting provided by the DRP may be based on a diagnostic test and or student profile information. A DRP provides the student with a multi-page DRP that contains very specific information that may include a narrative study plan that illustrates a course of study through products.

Agent reports, such as class aggregate reports for principals and teachers, are provided to institutional settings through the integration of the OLTP and other management systems. Reports can be used as online assessment tools and provide navigation between and among a variety of data elements using a browser. Reports can include single test reporting and aggregate test reporting, complete test history (e.g., answer selection history, time per questions, performance), CAF results in either programmatic form or image/printable form.

Some sample report types will now be described. The exemplary reports fall into two general types: descriptive and interpretive. A descriptive report provides data detailing performance on one or more evaluated components. The data is typically expressed in numerical and graphic format and may be accompanied by nonvariable explanatory text.

Descriptive reports might differ in the scope and nature of data presented. For example a discrete report presents data for a single entity, such as the results for an individual test-taking or lesson-taking. A discrete report allows the student to scrutinize performance on the reported taking in isolation from other takings. Such a report might include question details in an item-level report associated with a discrete report. Question details provide the student access to individual questions with the correct answers and the student's answers indicated as well as any associated metadata, such as markings. Another such report is an aggregate report, which presents cumulative data for multiple entities of the same type, such as a performance in a category across a group of tests. An aggregate report allows the student to examine cumulative performance across entities.

A comparative report presents data for multiple entities of the same type, such as a set of diagnostic tests. The data is presented in a manner intended to facilitate comparisons across the reported entities. A comparative report may contain both discrete and aggregate data.

Interpretive reports interpolate data with performance-specific messages. Examples of reports are listed in Table A.3(a) in Appendix A. Examples of a Diagnostic Report Package is shown as Table A.3(b) in Appendix A. A Diagnostic Report Package (DRP) is a set of materials intended to provide a reflection of a student's current performance level in a content area and concrete suggestions for improvement. A DRP can be generated by OLTP 60 processing data from one or more diagnostic measures, such as a diagnostic test or a questionnaire. A DRP can also map to instructional content that is offline (e.g., print-based), online (within the course producing the DRP), or a hybrid of offline and online. A DRP often has one or more of the elements shown in Table A.3(b).

Curriculum Delivery System

Overview: A course in the Online Learning Platform is defined in terms of which units, lessons and/or tests are included in the course Study Plan. Course components could include: study plans, units, lessons, tests, tutorials, references tools, reporting, academic support, and help. Unit content may vary in terms of which lessons, tests and reference tools are included within the unit. Lessons and tests may vary in terms of (1) the number of included lesson or question items and (2) which type of lesson and question items are included. Student reports are either standard statistical analysis or rich assessment feedback reports, which can include narrative descriptions of a recommended course of study. In addition courses may contain supplement components such as references and tools. The OLTP can support an internal context sensitive glossary and link to a flashcard tool.

A basic tutorial products category supports the delivery of simple and complex lessons on a standalone basis or with the integration of test components as defined above.

A prescriptive learning product category includes a collection of components as well as rules for (1) prescriptive content delivery for a custom study plan, or (2) product customization based on properties such as geographic location or instructional agency as criteria for determining content and navigation parameters of a course. The system gathers student profile preferences from the end-users via a website and/or enrolled data and/or uses information from diagnostic assessments to deliver a customized study plan and a unique learning experience to a student.

An OLTP inference process applies a product designer's rules to student data to produce an individualized study plan to address the student's specific learning needs. Individualization may occur by a) providing a set of recommended components, b) changing the strength of recommendations for a set of components or c) a combination of both. The rules for recommending instructional lessons, tests and supplemental materials can be inputted into the prescriptive instruction system through the CMS and CPS.

The study plan can be provided up front as a student starts to use a body of instructional material, such as via a main menu. The study plan offers the scope and sequence of “plannable” components that may accessed by students as part of an online curriculum experience. The plannable components might include components identified as Units, Lessons and Tests.

When developing a course in the system, the instructional designer would plan the set of course materials for a given enrollment and determine the course control strategies that will be applied to the plan-able components. The study plan can be generated and viewed within a local online system or remotely, such as over the Web.

Study plans can contain any type of plan-able component (i.e., Units, Lessons, Tests, and Custom Test Factories) that are contained within the OLTP, as well as links to PDF files served by the OLTP, links to third-party, stand-alone applications (e.g., Flash Flashcards) and/or unlinked text (e.g., an instruction to do an offline activity). A study plan might include information pertaining to recommendation levels, date last accessed, score, status, progress, etc., where some of the elements are calculated values (e.g., for third-party stand alone applications or for third party websites), for each plan-able component of the study plan.

Unit and Lesson Structure

A Unit is an aggregation of Lesson and/or Tests components in a defined grouping. A Lesson is a predefined sequence of instructional deliverable items addressing one or more closely related learning. Each instructional deliverable item, also known as a Lesson Item, is developed to support, or evaluate, a single learning objective. The Instructional Designer can support the teaching of the learning objective using as many Lesson Items as they desire. The OLTP can supports Lesson Item types such as Instruction, Activity, Exercise and Supplement.

Lesson Item Types

1. Instruction Items require no explicit user interaction and apply to items such as text, reading passages, static graphics, animated graphics, or links to other Lesson Items, content-sensitive content, downloadable objects and the like.

2. Activity Items include user interaction that is not evaluated and not tracked by the system, such as self-contained experiential elements, text or instructions to perform offline activity, or animated graphics with user controls such as manipulated elements.

3. Exercise Items include student-response data recorded by the OLTP, immediate evaluation items, correct/incorrect response messages, explanations (may be provided by system or at the student's request), hints (may be provided by system or at the student's request), and the like. Response types can be optional, required or under course control, a response contributed to lesson completion and performance information. Some exercise items are gated, in that a correct response is required before proceeding to the next item in a lesson sequence, such as for verifying comprehension. Exercise items might also include response support, where a hint or explanation is provided after an incorrect answer.

4. A Supplemental Item might be an optional Lesson Item or sequence of Lesson Items to extend or review a concept and might be limited to use only when some students need additional information, preferably not including exercise items. A Lesson may have zero or more links to Supplemental Items

Course Control

The OLTP provides a unique set of rules that provide course controls within a Unit, Lesson or Course. The course controls allow an instructional designer to structure students' paths through course content. Course control can be access control, achievement control, or a combination thereof. For access control, preconditions need to be met before allowing access to a component and constraints can be placed on how many times a component may be repeated. For achievement control, a student stays on a component until conditions are met such that the component is considered finished or until comparisons between student performance and specified benchmark criteria indicate completion. Course controls are optional and may be used in combination, thus providing great flexibility in supporting variations in course designs.

Authoring Example

FIG. 9 is a sequence of screen shots (FIGS. 9A-9E) illustrating a process of authoring content. One pass through an authoring session is shown in FIGS. 9A-9E. Each of these figures is a simplified screen shot of an exemplary application.

The authoring tools provide a software environment where authors create question and lesson content. The tools can automatically and transparently encode the content with XML tags to provide compatibility and consistency with the CMS data model. Support of content creation includes producing the associated files, including the productItem files and product Delivery Rules files described below, as well as the item and content files. A “productItem” is represented by an XML file with metadata describing the instructional content's pedagogic and reporting categorization within a course; productItem also might contain a one-to-one reference with an XML file containing instructional content to be presented within the course. A “productDeliveryRules” is represented by an XML file containing instructions on how a piece of instructional content is delivered and processed within the course. For example, a productDeliveryRule determines if a question must be answered before continuing within the course and if a question will be evaluated.

The authoring tools provide authors with the ability to choose between creating lesson items and creating test question items. The configurable environment allows the author to enter into handle content for a test-specific area (such as GRE, GMAT, SAT, etc.) and use global and specific text and structural formatting types configured for specific question types of that test. Authors can create templates for specific presentation layouts for lessons.

The authoring tools include presentation tools, such as tools for specifying format, such as text formatting using predefined emphasis types and XHTML, visually formatting text, inserting special characters and symbols, text copy, cut and paste, etc. The authoring tools also include tools for inserting inline and/or stand-alone media references into content either by browsing/searching a repository for preexisting media items or by allowing the author to add media items at time of content creation.

Using the authoring tools, an author can insert and apply layout-related formatting (e.g., bulleted lists, test question stem/choices), enter question item sets in a continuous setting (vs. individual question items), locate all content types (e.g., questions, lesson pages, static media, rich media) within the repository by searching on associated metadata, preview content page layout prior to publishing of the complete product to the OLTP and lay out a course structure by arranging a sequence of pages into units, lessons and tests. The authoring tools also allow authors to communicate to product assembly, the structure of a course as well as content files included in the course's units/lessons/tests.

As shown in FIG. 9A, an author indicates that a new file is to be started for a lesson and selects a type for the new file; “Lesson Page” in this example. Other file types might include Lesson Page, Test Question Item, Test Tutorial Item, etc. As shown in FIG. 9B, the author can then type in text associated with the file and apply formatting. As shown in FIG. 9C, the author can add other structures to the file, such as images, rich media, side bars (e.g., side bar 310), tip bars, etc. Some structures might have substructures, such as side bar 310 having a header area and a content area where the author can insert separate text and possibly other data. Another example is tip bar 312 shown in FIG. 9D.

In addition to text, the author can insert images or other objects, as shown in FIG. 9D, with options to align the objects to the text in various ways (e.g., left, right, centered). Text can be formatted using a format menu or using icons. Links can also be added to the text, such as by including a URL as part of an anchor. Once the author enters the remaining text of the lesson, the author can add metadata for the file, as illustrated in FIG. 9E and save the file or perform other actions.

Thus, although the invention has been described with respect to exemplary embodiments, it will be appreciated that the invention is intended to cover all modifications and equivalents within the scope of the following claims.

APPENDIX A
Table A.1. Sample Product
Definition Parameters (PDP) Table

| | | |
|---|---|---|
| Parameter | Description | Options |

I. Functionality

| | | |
|---|---|---|
| Product Class | The name of the product class that | Custom Test/Drill and |
| | the course is defined by | Practice/Continuing Ed/ |
| | | Prelicensing |
| Product Line | The name of the product name that | NAPLEX |
| | the course is defined by. This may | |
| | correlate to a specific look and feel, | |
| | e.g. GMAT | |
| Product Release Version | The version number for the product | 1.0.0 |
| Minimum KLP Version | The minimum version of the KLP | R2 |
| | that the product is expected to | |
| | normally function on | |

Course Definition

| | | |
|---|---|---|
| Plannable Component List | List of plannable components to be | Custom Tests |
| | included in the course. Plannable | |
| | course components are: Units, | |
| | Lessons, Predefined Tests, Custom | |
| | Tests | |
| Study Plan Display Order | List of plannable components that | Custom Tests |
| | will be included in the Study Plan in | |
| | the desired display sequence | |
| Course Completion Criteria | The rules that determine whether | N/A |
| Strategy | the course has been completed by | |
| | the user | |
| Course Passing Criteria | The rules that determine whether | Not Applicable |
| Strategy | the course has been passed by the | |
| | user | |
| Category Definition | Data values comprising the | No Categories |
| | categories | |
| Difficulty Level Scale | The internal numerical scale | 0 |
| | representing the range of Difficulty | |
| | Levels | |
| Difficulty Level UI Mapping | Mapping of Difficulty Level UI | 0 = N/A |
| | presentation (e.g. 1, 2, 3) to internal | |
| | numerical scale representation | |
| Item Flag Number | The number of Item Flags to be | 0/1/2 |
| | included | |
| Item Flag Labels | Text values for one or both Item | “Guess” |
| | Flags | |

Specify for each plannable course component:

| | | |
|---|---|---|
| Plannable Component Display | Name of the plannable component | NAPLEX Quiz Bank |
| Name | that is to be displayed in the UI | |
| Plannable Component Type | The plannable component type | Specify the type: Unit/ |
| | | Lesson/ |
| | | System-Generated Test/ |
| | | Custom Test |
| Plannable Component | The plannable component | NAPLEX Quiz Bank |
| Classification | classification as a “Final Exam” or | |
| | other instructional construct. There | |
| | are no pre-set classifications; they | |
| | are fully definable by the product | |
| | designer. | |
| Recommendation Level | Whether the plannable course | Required/Optional |
| | component is required or optional. | |
| | For R2, this data is for display | |
| | purposes only (versus course | |
| | control). | |
| Plannable Component | The rules that determine whether a | Select rule(s): Final |
| Completion Criteria Strategy | plannable component has been | exam taken/Final exam |
| | completed by the user | passed/All lesson |
| | | materials accessed/ |
| | | Specified amount of time |
| | | spent in lesson content/ |
| | | Unit posttest taken/Unit |
| | | posttest passed/ |
| | | Additional rules: All |
| | | interactive lesson items |
| | | completed with correct |
| | | responses on last attempt/ |
| | | Last question answered |
| | | (if reverse navigation is |
| | | not permitted)/Time limit |
| | | reached/Student invoked |
| | | exit |
| Plannable Component Passing | The rules that determine whether a | Select strategy: TBD |
| Criteria Strategy | plannable component has been | |
| | passed by the user | |
| Plannable Component Scoring | The rules that determine how a | Select strategy: TBD |
| Strategy | plannable component should be | |
| | scored | |
| Plannable Component | The rules that determine how a | Select strategy: TBD |
| Termination Strategy | plannable component may be | |
| | terminated | |
| Plannable Component Category | The category(ies) assigned to the | Provide category values |
| Value | specific plannable component | from the set of values |
| | | assigned to the course |
| | | overall |
| Plannable Component Difficulty | The Difficulty Level assigned to the | Provide Difficulty Level |
| Level | specific plannable component | values from the range of |
| | | values defined for the |
| | | course overall |
| Item Selection Strategy | The rules for selecting items for the | Select: Random/ |
| | Plannable Component, in the case | Predefined |
| | of Tests and Lessons | |
| Delivery Mode | The Delivery Mode that a Test or | Select Mode: Test |
| | Lesson should be presented in | simulation/Practice/ |
| | | Examination |

Delivery Modes (For each Delivery Mode, specify the following)

| | | |
|---|---|---|
| Timing Mode | Whether a test is untimed or timed. | Untimed/System |
| | A test may be defined as timed by | Selected Timed/Student |
| | the product designer or the option | Selected Timed |
| | may be provided to the user to take | |
| | the test in a timed mode. | |
| Timing Method | Whether timing occurs at the | Select method: |
| | Plannable Component, Section or | Plannable Component/ |
| | Selectable Item level | Section/Selectable Item |
| Timing Limit | Time limit for an independent | 80 |
| | element or a sum of elements | |
| | depending on the value of Timing | |
| | Method | |
| Test Suspend Inclusion | Inclusion of the ability to suspend a | Include/Do not include |
| | test | |
| Answer Confirm Inclusion | Inclusion of the presence of an | Include/Do not include |
| | Answer Confirm button in the UI | |
| Previous Item Navigation | Whether to include the ability to | Include/Do not include |
| Inclusion | navigate to the Previous Item | |
| Response Evaluation Message | Whether the Response Evaluation | Include/Do not include |
| Inclusion | Message feature (e.g. Your answer | |
| | is correct/incorrect) should be | |
| | included in the UI | |
| Explanation Inclusion | Whether the Explanation feature | Include/Do not include |
| | should be included in the UI | |
| Explanation Link Display | Defines where the Explanation link | With Response |
| | should be presented | Evaluation Message/ |
| | | External to Response |
| | | Evaluation Messages/ |
| | | Both |
| Item Flag Inclusion | Whether the Item Flag feature | Include/Do not include |
| | should be included in the UI | |
| Item Review Inclusion | Whether to include the ability to | Include/Do not include |
| | access Test Item Review | |
| Lesson Display Mode | Whether the Test or Lesson UI is | Component Region/ |
| | displayed within the Component | Pop-up |
| | Region or as a separate pop-up | |
| | window | |
| Flashcards Access | Whether to allow access to | Access/No access |
| | Flashcards while taking a test or | |
| | lesson | |
| Tips Access | Whether to allow access to Tips | Access/No access |
| | while taking a test or lesson | |
| Reports Access | Whether to allow access to Reports | Access/No access |
| | while taking a test or lesson | |
| Question Report Access | Whether or not to permit the | Access/No access |
| | Student to access/view the | |
| | Question Report (which provide | |
| | answer details) while taking a Test | |
| | or Lesson, if access to Reports is | |
| | available | |
| Glossary Access | Whether to allow access to | Access/No access |
| | Glossary while taking a test or | |
| | lesson | |
| Help Access | Whether to allow access to Help | Access/No access |
| | while taking a test or lesson | |

General Test Parameters (For each Test, specify the following)

| | | |
|---|---|---|
| Total Number of Items in Test | The total number of items included | 185 |
| | in a test | |
| Test Item List | List of items that may be included in | Determined by Business |
| | a test. This may be a preordained, | Unit |
| | nonvariable list of items or a set of | |
| | items from which a given test may | |
| | be generated. If a semblance of | |
| | weighting by category and/or | |
| | difficulty level is desired, the list | |
| | should be | |
| Test Mode Instructions | Provide option for the user to skip | May skip/May not skip |
| Skippable | test mode instructions (I.e. practice, | |
| | simulation, examination mode) | |
| Target Test Instructions | Provide option for the user to skip | May skip/May not skip |
| Skippable | target test instructions (I.e. test | |
| | emulation) | |

Custom Test (For each Custom Test, specify the following)

| | | |
|---|---|---|
| Number of Items Allowed | The maximum number of items | 185 |
| | allowable for a custom test | |
| Difficulty Level UI Inclusion | Inclusion of Difficulty Level in UI | Include/Do not include |
| | versus in item data | |
| Reuse UI Inclusion | Inclusion of Reuse Heuristic | Include/Do not include |
| Reuse Values | Definition of reuse heuristic values | All/Not Used/Incorrect |
| | | Only/Incorrect and Not |
| | | Used |
| Default Test Name | The name that will be offered to the | Test 1 |
| | Student at point of test creation. It | |
| | may be overridden by the Student | |

Lessons (For each lesson, specify the following)

| | | |
|---|---|---|
| Sequence of Instructional Items | A list of the instructional item | N/A |
| | identifiers in the order that the items | |
| | will be displayed | |
| Supplemental Items | A list of linked supplemental items | N/A |
| | represented in the order that they | |
| | will be displayed | |

Item Set (For each item set, specify the following)

| | | |
|---|---|---|
| Performance Calculation | The rules for calculating | Percent Correct |
| Strategy | performance on an item | |
| Next Item Strategy | The rules for determining which | Sequential |
| | item to present next | |
| Item Selection Strategy | The rules for selecting selectable | Select: Random/ |
| | items for the item set | Predefined |
| Item Set Time Limit | The maximum amount of time | Provide an integer in |
| | allowable for the Student to select | milliseconds |
| | an answer choice | |
| Shuffle Enabled | Whether a items should be shuffled | Yes/No |
| | in the case of a new taking of a | |
| | system-generated test | |

Selectable Item (For each selectable item, specify the following)

| | | |
|---|---|---|
| Shuffle Override | If shuffling is enabled, the ability to | Yes/No |
| | prevent the shuffling of selectable | |
| | items, e.g. in the case of Reading | |
| | Comprehensive items that build | |
| | upon each other | |
| Selectable Item Category Value | The category(ies) assigned to the | See Category XML doc |
| | selectable item | |
| Selectable Item Difficulty Level | The Difficulty Level assigned to the | 0 |
| | selectable item | |
| Required Items | List of items that MUST be included | none |
| | in the test, if any | |

Deliverable Item (For each deliverable item, specify the following)

| | | |
|---|---|---|
| Question ID (QID) | The Customer Service or Vendor | Specify the identifier |
| | number associated with the item, | (Definable by Business |
| | e.g. typically used by Customer | Units) |
| | Service to reference an item that | |
| | the Student is having a problem | |
| | with | |
| Deliverable Item Category | The category(ies) assigned to the | See Category Doc |
| Value | deliverable item | (Definable by Business |
| | | Units) |
| Deliverable Item Difficulty Level | The Difficulty Level assigned to the | 0 |
| | deliverable item | |
| Response Expected | Whether a response to an item is | Yes/No |
| | expected, e.g. in the case of test | |
| | items and lesson activities and | |
| | exercises | |
| Response Scorable | Whether a response should be | Yes/No |
| | scored e.g. in the case of test items | |
| | and lesson exercises | |
| Response Evaluatable | Whether a response should be | Yes/No |
| | evaluated e.g. in the case of lesson | |
| | activities | |

Intro Sequence and Navigation Parameters

| | | |
|---|---|---|
| Orientation Inclusion | Inclusion of Orientation | Include/Do not include |
| Orientation Skippable | If included, provide option for user | May skip/May not skip |
| | to skip the Orientation | |

Reporting

| | | |
|---|---|---|
| Report Classification Display | The order of Plannable Component | Define the order of |
| Order | Classifications by which reports will | Plannable Component |
| | be displayed | Classifications |

References

| | | |
|---|---|---|
| Glossary Inclusion | Inclusion of Glossary | Include/Do not include |

Help and Support

| | | |
|---|---|---|
| Help Inclusion | Inclusion of Help | Include/Do not include |
| Academic Support | Inclusion of Academic Support | Include/Do not include |
| Technical Support | Inclusion of Technical Support | Include/Do not include |

II. Look and Feel

| | | |
|---|---|---|
| Look and Feel Style Template | Choice of the UI template that will | KTP Grad/ |
| | comprise both the top horizontal | KTP K12/ |
| | branding and navigation region | KTP USMLE/ |
| | (product region) and the content | Financial/ |
| | region (component region) | Real Estate/ |
| | | Custom |

Logos (Images provided and/or selectable by business units)

| | |
|---|---|
| Product Name Logo | Provide graphics for inclusion in the |
| | Welcome screen and branding |
| | region. |
| Business Unit/Product Group | Provide graphics for inclusion in the |
| | Welcome screen and branding |
| | region. |
| Co-Branding Partners | Provide graphics for inclusion in the |
| | Welcome screen and branding |
| | region. |

III. Component Region UI

| | | |
|---|---|---|
| Test Interface | Choice of the Test (test taking and | Best Practices/ETS/ |
| | item review) component UI which | NASD |
| | may be either the Best Practices | |
| | Test UI or a standardized test | |
| | format UI. | |

IV. UI Variable Copy (For Options, use Variable Copy Doc options (Definable by Business Unit))
Welcome Page

| | |
|---|---|
| Product Name | Name of the product in text format |
| | (versus graphic) |
| Publisher Name(s) | |
| Copyright | Copyright language |
| Trademark | Trademark language |
| Salutation | Salutation to the first time user, e.g. |
| | “Hi” or “Hello” |
| Return Salutation | Salutation to the returning user, e.g. |
| | “Welcome back” |
| Welcome Message | Welcome message to the first time |
| | user |
| Welcome Back Message | Welcome back message to the |
| | returning user |
| Learning Objectives | Statement of course learning |
| | objectives |

Orientation Page

| | |
|---|---|
| Orientation | Product orientation message |

Test

| | |
|---|---|
| Test Directions —Test Simulation | The instructions presented to the |
| Mode | user before entering a test in Test |
| | Simulation mode |
| Test Directions —Practice Mode | The instructions presented to the |
| | user before entering a test in |
| | Practice mode |
| Test Directions —Examination | The instructions presented to the |
| Mode | user before entering a test in |
| | Examination mode |
| Test Directions —Pre-defined | The instructions presented to the |
| Test | user before entering a pre-defined |
| | test |
| Standard Test Format | The instructions presented to the |
| Directions | user before entering a test |
| | presented in a Standardized Test |
| | Format UI |

Study Plan

| | |
|---|---|
| Course Objectives | Course objectives presented on the |
| | parent Study Plan page |

Other

| | |
|---|---|
| Help | Help copy that is custom to the |
| | course |

Table A.2. CAF Logic Tests

| | | |
|---|---|---|
| Code | Title | Description |

Table A.2(a) Classic Logic Trees

| | | |
|---|---|---|
| QC | Quantity Correct | Out of the cited questions, if more than a certain number are correct, |
| | | the test returns TRUE. |
| | | e.g., 4, 3, 5, 9, 10, 15 |
| | | The first number is the “certain number.” |
| | | If greater than 4 of questions 3, 5, 9, 10, 15 are correct, the test |
| | | returns true. |
| QS | Quantity | Out of the cited questions and a.c.s., if more than a certain number |
| | Specific | are the student's responses, the test returns TRUE. |
| | | e.g., 4, 3A, 3C, 9_, 10C, 15D |
| | | The first number is the “certain number.” |
| | | If greater than 4 of questions of the following responses were given |
| | | by the student, the test would return true: Question 3, choice A or C; |
| | | Q9 left blank; Q10 choice C; Q15 choice D. |
| QO | Quantity | Out of the cited questions, if more than a certain number were |
| | Omitted | omitted, the test returns TRUE. |
| | | e.g., 4, 3, 5, 9, 10, 15 |
| | | The first number is the “certain number.” |
| | | If greater than 4 of questions 3, 5, 9, 10, 15 were omitted, the test |
| | | returns true. |
| BL | Blanks | If there is one or more blank on the entire test, BL returns TRUE. |
| FS | Final Score | This test looks at what is stored in the “Final Score” field of the score |
| | | history database and sees if it is greater than a certain number. |
| | | e.g., 129 |
| | | Is the score greater than a 120 (say, on the LSAT)? |

Table A.2(b) Advanced Logic Trees

| | | |
|---|---|---|
| MS | Macro | Interprets and evaluates logical expression with variables. Can use |
| | Substitution | the “sorter” function allowing comparison of values. |
| | | e.g. score (1, 1) > score (2, 1) + 40 |
| | | score (1, 1) = Quantitative scaled score on this test |
| | | score (2, 1) = Quantitative scaled score on previous test (by date) |
| | | If Q score on this test is 40 points higher than previous Q score, then |
| | | the test returns true. |
| VA | Variable | Can create a variable for subsequent logic tests. This test is not |
| | Assignment | evaluated as true or false. |
| | | e.g. weakscore = sorter(“3; score(1, 1); score (1, 2); score (1, 3); 1”)* |
| | | The sorter function returns the xth lowest value. X is the last number |
| | | of the function. Here, we are looking for the lowest scaled score (Q, |
| | | V, or A) on the current test. Rather than repeatedly having to call the |
| | | function (wasting processing time), we can test for the value of |
| | | weakscore. |
| LP | Lesson/Study | A 2-digit character string representing one of the 45 Study Plans |
| | Plan | (GMAT) is determined elsewhere in the program (e.g. “13” or “07”). |
| | | When this Logic Tree type is invoked, it just prints whichever Lesson |
| | | Plan was selected for this student and then goes on to the next logic |
| | | tree (via the “goto true” field). The PICT number for Lesson/Study |
| | | Plans is “90” + the 2-digits representing the study plan. While Study |
| | | Plans can be determined within the logic tree structure, |
| | | time-consuming or complicated logic designs are handled within the |
| | | program. It is only the latter case that necessitates the LP Logic type. |

Table A.2(c) Functions

| | | |
|---|---|---|
| | * Sorter | This function is used in the advanced logic tree types. It returns the |
| | | name of the variable (uppercase) that holds a particular rank among |
| | | a specific set of variables. Numeric and character variable values are |
| | | sorted in ascending order. You can then look for the variable that |
| | | holds a specified place in the ordering of the values. The syntax: |
| | | sorter(“x; var1; var2; . . . varx; n”) |
| | | Where x is the number of variables being considered. |
| | | var1 . . . are the names of the variables (or array elements), and |
| | | n is the nth lowest value which you are looking for. |
| | | For example, sorter(“3; score(1, 1); score(1, 2); score(1, 3); 1”) will return |
| | | the (1st) lowest scaled score attained on the current test. If the |
| | | student scores were 450Q (score(1, 1)), 370V (score (1, 2)), 580A |
| | | (score (1, 3)), then the sorter function would return SCORE (1, 2). |
| ST | SAY TEXT | Prints whatever text occurs in criteria field. |
| SV | SAY VARIABLE | Prints the value of the variable occurring in criteria field. |

Table A.3. Example Reports
Table A.3(a) Specific Reports

| Name | Description | Data |
|---|---|---|
| Individual Tests Main | List of all student-created | For each test: |
| | tests | number correct |
| | | number attempted |
| | | percentage correct |
| | | status |
| Individual Test | Overview of an individual | For selected test: |
| Summary | test | number correct |
| | | number attempted |
| | | MARK_1 (if used) |
| | | MARK_2 (if used) |
| | | total changed |
| | | number changed incorrect to |
| | | correct |
| | | number changed correct to |
| | | incorrect |
| | | number changed incorrect to |
| | | correct |
| | | category performance summaries |
| Question Details | List of all items for an | For each test item in selected test: |
| | individual test (sub-report of | sequence number |
| | Individual Test Summary) | unique identifier |
| | | whether correct, incorrect, or |
| | | incomplete |
| | | associated category name |
| | | how changed |
| | | how marked |
| | | difficulty |
| Category Details | Overview of performance in | For each category in selected test: |
| | each category tested on an | category name |
| | individual test (sub-report of | number correct |
| | Individual Test Summary) | number attempted |
| | | percentage correct |
| Category Summaries | List of performance in each | For each category across all tests: |
| | category summarized | category name |
| | across all tests | number correct |
| | | number attempted |
| | | percentage correct |
| Category by Test | List of all tests showing | For each test: |
| | performance for the | number correct |
| | selected category within | number attempted |
| | each test (sub-report of | percentage correct |
| | Category Summaries) | |
| Question Summary | Overview of performance | Of all items: |
| | across all items | total available |
| | | number attempted |
| | | number correct on first attempt |
| | | number correct on most recent |
| | | attempt |
| | | total changed |
| | | number changed incorrect to |
| | | correct |
| | | number changed correct to |
| | | incorrect |
| | | number changed incorrect to |
| | | incorrect |
| Lesson Reports | List of all lessons | For each lesson: |
| | | categories (if applicable) |
| | | number correct on first attempt |
| | | number correct on most recent |
| | | attempt |
| | | number possible (attempted) |
| | | percentage correct (if applicable) |
| | | repetitions |
| [criterion-referenced | | For each test (in addition to data for R1 |
| tests] | | Test Summary): |
| | | passing criterion |

Table A.3(b) Diagnostic Report Package

| Element | Purpose | Application |
|---|---|---|
| Descriptive Statistics (Analysis) | Display numeric and graphic results | any product |
| | of one or more diagnostic tests | |
| Narrative Messages (Diagnostic | Relay nonvariable and/or variable | any product |
| Profile, Diagnostic Feedback) | text-based information related to | |
| | performance on diagnostic measures | |
| Question Details (Report | Display student's responses to test | any product with one or |
| Answer Review) | questions with indication of whether | more online diagnostic |
| | responses were correct, incorrect, or | tests |
| | omitted | |
| Response Summary (includes | Display both correct and student's | product without an online |
| an answer key) | responses to test questions; | diagnostic test |
| | summarize some question | |
| | performance information | |
| Study Time Allocation (Study | Prioritize study topics and allocate | product without online |
| Plan Summary, time budget) | blocks of time to each topic | instruction |
| Offline Study Plan | Prescribe an offline course of study | product without online |
| | | instruction (or a hybrid of |
| | | online and offline |
| | | instruction) |

What is claimed is:

1. A distributed learning system, wherein a plurality of students interact at remote locations with a centrally controlled system to obtain online curriculum materials including tests and lessons, comprising:
a student database for maintaining student records for the plurality of students; and
a prescriptive analyzer for generating a prescriptive lesson plan for a student accessing the distributed learning system from student records in the student database for that student, wherein the prescriptive analyzer uses as its input the student's responses to questions in the form of one or more of pattern matching, percentage correct and distractor analysis, where the questions are items in an atomic component storage and the student's responses are grouped according to plans arranged into lessons or tests.

2. An online curriculum handling system, wherein a plurality of students interact with curricula supported by the online curriculum handling system using computers, the online curriculum handling system comprising:
a content management system, wherein atomic content components are stored independently of product content;
a student profile database;
a database of product assembly templates;
a product publishing system including means for constructing an online curriculum product for use by the plurality of students with references to atomic content components stored in the content management system using at least one product assembly template from the database of product assembly templates, wherein a product indicated as customizable can be automatically customized for a given student from the information stored in the student profile database for the given student; and
a feedback module for updating student profiles in the student profile database in response to student activity with respect to published products.

3. The online curriculum handling system of claim 2, wherein the student profile database includes target skill sets, assessment levels and prior test performance for at least some of the plurality of students.

4. The online curriculum handling system of claim 2, wherein the atomic content components are organized according to a taxonomy.

5. A method of searching an atomic content management system, comprising:
resolving references to identify atoms in context;
extracting referenced atoms;
transferring the extracted atoms into a searchable format;
removing at least one element from the transformed data where the removed element is not relevant for the search; and
searching over the results after the step of removing.

6. The method of claim 5, further comprising adding the extracted atoms to database table using database tools that are independent of the extracted atoms' content.
